(19) United States
(12) Patent Application Publication
(10) Pub. No.: US 2026/0301251 A1
(43) Pub. Date: Oct. 1, 2026

(54) SYSTEMS AND METHODS FOR PREDICTING AND DYNAMICALLY DISPLAYING PEST PRESSURE

(71) Applicant: FMC CORPORATION, Philadelphia, PA (US)

(72) Inventors: Joseph DAVIS, Philadelphia, PA (US); Frank TSENG, Philadelphia, PA (US); Andrew SCHNEIDER, Philadelphia, PA (US); Shabenoor KAMAL, Philadelphia, PA (US)

(21) Appl. No.: 19/480,415

(22) PCT Filed: May 2, 2024
(86) PCT No.: PCT/US2024/027431

§ 371 Date: Oct. 31, 2025

Related U.S. Application Data
(60) Provisional application No. 63/464,000, filed on May 4, 2023.

(51) Int. Cl. G06T 11/26; G06F 3/04847; G06F 16/29; G06T 11/10

(52) U.S. Cl. CPC G06T 11/26; G06F 16/29; G06T 11/10; G06F 3/04847; G06T 2200/24

(57) ABSTRACT

System and methods for predicting future pest pressures are provided. A pest pressure prediction computing device is programmed to receive historical pest pressure data and weather data for a geographic location, apply a machine learning algorithm to the historical pest pressure data and the weather data to generate predicted future pest pressure data, determine, from the predicted future pest pressure data, for each of a plurality of geographic regions, associated predicted pest pressure values, an associated predicted peak pest pressure, and an associated peak pressure estimated arrival time, cause a computing device to display each of the plurality of geographic regions in a color corresponding to the associated peak pressure estimated arrival time, and cause the user computing device to display a particular geographic region in association with a graph that indicates the predicted pressure values and when the predicted peak pest pressure for that particular geographic region.

### CROSS-REFERENCE TO RELATED APPLICATIONS

The present application claims priority to U.S. Provisional Patent Application No. 63/464,000, filed May 4, 2023, which is incorporated by reference herein in its entirety.

### BACKGROUND

The present application relates generally to a technology that may be used to assist in predicting pest pressure, and more particularly, to network-based systems and methods for predicting and dynamically displaying pest pressure information.

Due to the world's increasing population and decreasing amount of arable land, there is a desire for methods and systems to increase the productivity of agricultural crops. At least one factor that impacts the productivity of agricultural crops is pest pressure.

Accordingly, systems and methods have been developed to monitor and analyze pest pressure. For example, in at least some known systems, a plurality of insect traps are placed in a field of interest. To monitor the pest pressure in the field of interest, the traps are inspected regularly to count the number of pests in each trap. Based on the number of pests in each trap, a pest pressure level for the field of interest can be determined.

The number of pests monitored in each trap may also be used to predict future pest pressures. However, pest pressure is a relatively complex phenomenon that is governed by several factors. Thus, accurately predicting future pest pressures based primarily on trap counts may be relatively inaccurate. Further, at least some known systems for pest pressure monitoring are focused at an individual farm level, resulting in limited visualizations and significant time lag in data collections. In addition, at least some known systems for predicting future pest pressure rely on static logic (e.g., fixed phenology models and/or decision trees), and are accordingly limited in their ability to accurately predict future pest pressure.

Accordingly, it would be desirable to provide a system that captures and intelligently analyzes a plurality of different types of information to quickly and accurately predict future pest pressures. Further, it would be desirable to dynamically present predicted future pest pressures to users in a straightforward and intuitive way, in order to assist users in performing the technical task of monitoring pest pressure, and optionally controlling a pest trap system and/or a pest treatment system.

### BRIEF DESCRIPTION

In one aspect, a pest pressure prediction computing device is provided. The pest pressure prediction computing device includes a memory, and a processor communicatively coupled to the memory, the processor programmed to receive historical pest pressure data for a geographic location, the historical pest pressure data including current and past pest pressure data for the geographic location, receive weather data for the geographic location, the weather data including current and historical weather conditions for the geographic location, apply a machine learning algorithm to the historical pest pressure data and the weather data to generate predicted future pest pressure data for the geographic location, determine, from the predicted future pest pressure data, for each of a plurality of geographic regions within the geographic location, associated predicted pest pressure values, an associated predicted peak pest pressure, and an associated peak pressure estimated arrival time, cause a computing device to display the plurality of geographic regions, wherein each geographic region is displayed in a color corresponding to the peak pressure estimated arrival time associated with that region, and cause, in response to a user input on the computing device that selects a particular geographic region of the plurality of geographic regions, the user computing device to display the particular geographic region in association with a graph that indicates the predicted pressure values for that particular geographic region over time, and that indicates when the predicted peak pest pressure for that particular geographic region is expected to occur.

In another aspect, a method for generating and displaying pest pressure predication data is provided. The method is implemented using a pest pressure prediction computing device including a memory communicatively coupled to a processor. The method includes receiving historical pest pressure data for a geographic location, the historical pest pressure data including current and past pest pressure data for the geographic location, receiving weather data for the geographic location, the weather data including current and historical weather conditions for the geographic location, applying a machine learning algorithm to the historical pest pressure data and the weather data to generate predicted future pest pressure data for the geographic location, determining, from the predicted future pest pressure data, for each of a plurality of geographic regions within the geographic location, associated predicted pest pressure values, an associated predicted peak pest pressure, and an associated peak pressure estimated arrival time, causing a computing device to display the plurality of geographic regions, wherein each geographic region is displayed in a color corresponding to the peak pressure estimated arrival time associated with that region, and causing, in response to a user input on the computing device that selects a particular geographic region of the plurality of geographic regions, the user computing device to display the particular geographic region in association with a graph that indicates the predicted pressure values for that particular geographic region over time, and that indicates when the predicted peak pest pressure for that particular geographic region is expected to occur.

In yet another aspect, a computer-readable storage medium having computer-executable instructions embodied thereon is provided. When executed by a pest pressure prediction computing device including at least one processor in communication with a memory, the computer-readable instructions cause the pest pressure prediction computing device to receive historical pest pressure data for a geographic location, the historical pest pressure data including current and past pest pressure data for the geographic location, receive weather data for the geographic location, the weather data including current and historical weather conditions for the geographic location, apply a machine learning algorithm to the historical pest pressure data and the weather data to generate predicted future pest pressure data for the geographic location, determine, from the predicted future pest pressure data, for each of a plurality of geographic regions within the geographic location, associated predicted pest pressure values, an associated predicted peak pest pressure, and an associated peak pressure estimated arrival time, cause a computing device to display the plurality of geographic regions, wherein each geographic region is displayed in a color corresponding to the peak pressure estimated arrival time associated with that region, and cause, in response to a user input on the computing device that selects a particular geographic region of the plurality of geographic regions, the user computing device to display the particular geographic region in association with a graph that indicates the predicted pressure values for that particular geographic region over time, and that indicates when the predicted peak pest pressure for that particular geographic region is expected to occur.

### BRIEF DESCRIPTION OF THE DRAWINGS

FIG. 1-20B show example embodiments of the methods and systems described herein.

FIG. 1 is a block diagram of a computer system used in predicting pest pressures in accordance with one embodiment of the present disclosure.

FIG. 2 is a block diagram illustrating data flow through the system shown in FIG. 1.

FIG. 3 illustrates an example configuration of a server system such as the pest pressure prediction computing device of FIGS. 1 and 2.

FIG. 4 illustrates an example configuration of a client system shown in FIGS. 1 and 2.

FIG. 5 is a flow diagram of an example method for generating pest pressure data using the system shown in FIG. 1.

FIGS. 6-20B are screenshots of a user interface that may be generated using the system shown in FIG. 1

Although specific features of various embodiments may be shown in some drawings and not in others, this is for convenience only. Any feature of any drawing may be referenced and/or claimed in combination with any feature of any other drawing.

### DETAILED DESCRIPTION

The systems and methods described herein are directed to computer-implemented systems for predicting future pest pressures. A pest pressure prediction computing device includes a memory and a processor communicatively coupled to the memory. The processor is programmed to receive historical pest pressure data for a geographic location, the historical pest pressure data including current and past pest pressure data for the geographic location, receive weather data for the geographic location, the weather data including current and historical weather conditions for the geographic location, apply a machine learning algorithm to the historical pest pressure data and the weather data to generate predicted future pest pressure data for the geographic location, determine, from the predicted future pest pressure data, for each of a plurality of geographic regions within the geographic location, associated predicted pest pressure values, an associated predicted peak pest pressure, and an associated peak pressure estimated arrival time, cause a computing device to display the plurality of geographic regions, wherein each geographic region is displayed in a color corresponding to the peak pressure estimated arrival time associated with that region, and cause, in response to a user input on the computing device that selects a particular geographic region of the plurality of geographic regions, the user computing device to display the particular geographic region in association with a graph that indicates the predicted pressure values for that particular geographic region over time, and that indicates when the predicted peak pest pressure for that particular geographic region is expected to occur.

The systems and methods described herein facilitate accurately predicting pest pressure at one or more geographic locations. As used herein, a ‘geographic location’ generally refers to an agriculturally relevant geographic location (e.g., a location including one or more fields and/or farms for producing crops). Further, as used here, ‘pest pressure’ refers to a qualitative and/or quantitative assessment of the abundance of pests present at a particular location. For example, a high pest pressure indicates that a relatively large abundance (e.g., as compared to an expected abundance) of pests are present at the location. In contrast, a low pest pressure indicates that a relatively low abundance of pests are present at the location. In at least some of the embodiments described herein, pest pressure is analyzed for agricultural purposes. That is, pest pressure is monitored and predicted for one or more fields. However, those of skill in the art will appreciate that the systems and methods described herein may be used to analyze pest pressure in any suitable environment.

As used herein, the term ‘pest’ refers to an organism whose presence is generally undesirable at the particular geographic location, in particular an agriculturally relevant geographic location. For example, for implementations that analyze pest pressure for one or more fields, pests may include insects that have a propensity to damage crops in those fields. However, those of skill in the art will appreciate that the systems and methods described herein may be used to analyze pest pressure for other types of pests. For example, in some embodiments, pest pressure may be analyzed for fungi, weeds, and/or diseases. The systems and methods described herein refer to ‘pest traps’ and ‘trap data’. As used herein, ‘pest traps’ may refer to any device capable of containing and/or monitoring presence of a pest of interest, and ‘trap data’ may refer to data gathered using such a device. For example, for insects, the ‘pest trap’ may be a conventional containment device that secures the pest. Alternatively, for fungi, weeds, or diseases, the ‘pest trap’ may refer to any device capable of monitoring presence and/or levels of the fungi, weeds, and/or diseases. For example, in embodiments where the ‘pest’ is one or more species of fungi, the ‘pest trap’ may refer to a sensing device capable of quantitatively measuring a level of spores associated with the one or more species of fungi in the ambient environment around the sensing device. In one embodiment, the ‘pest’ is a type of insect or multiple types of insects, and the terms ‘pest trap’ and ‘pest traps’ refer to ‘insect trap’and ‘insect traps’, respectively.

The following detailed description of the embodiments of the disclosure refers to the accompanying drawings. The same reference numbers in different drawings may identify the same or similar elements. Also, the following detailed description does not limit the claims.

Described herein are computer systems such as pest pressure prediction computing devices. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to predicting pest pressure.

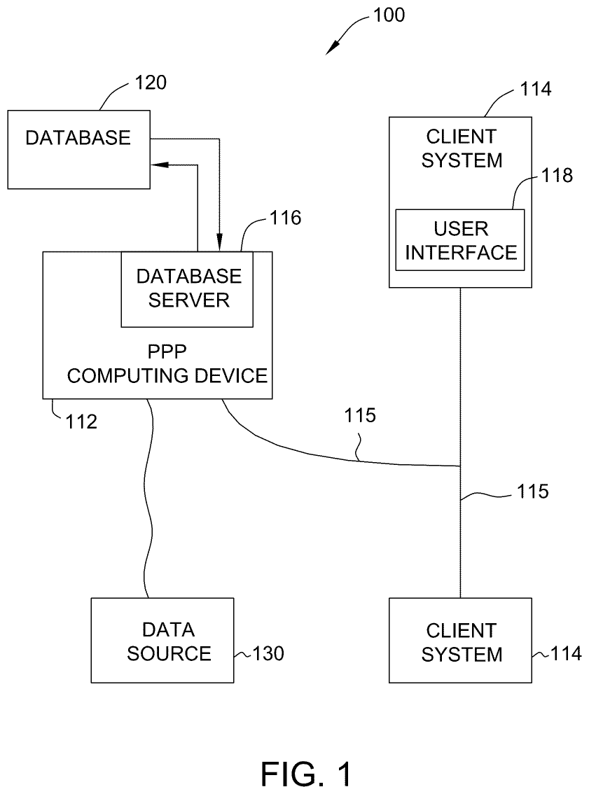

FIG. 1 is a block diagram of an example embodiment of a computer system 100 used in predicting pest pressures that includes a pest pressure prediction (PPP) computing device 112 in accordance with one example embodiment of the present disclosure. PPP computing device 112 may also be referred to herein as a heat map generation computing device, as described herein. In the example embodiment, system 100 is used for predicting pest pressures and dynamically displaying pest pressure information to a user (e.g., via a graphical user interface).

More specifically, in the example embodiment, system 100 includes pest pressure prediction (PPP) computing device 112, and a plurality of client sub-systems, also referred to as client systems 114, connected to PPP computing device 112. In one embodiment, client systems 114 are computers including a web browser, such that PPP computing device 112 is accessible to client systems 114 using the Internet and/or using network 115. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with farmers, growers, scouts, etc. as well as external systems used to store data. PPP computing device 112 is also in communication with one or more data sources 130 using network 115. Further, client systems 114 may additionally communicate with data sources 130 using network 115. Further, in some embodiments, one or more client systems 114 may serve as data sources 130, as described herein. Client systems 114 may be any device capable of interconnecting to the Internet including a web-based phone, PDA, or other web-based connectable equipment.

A database server 116 is connected to a database 120, which contains information on a variety of matters, as described below in greater detail. In one embodiment, centralized database 120 is stored on PPP device 112 and can be accessed by potential users at one of client systems 114 by logging onto PPP computing device 112 through one of client systems 114. In an alternative embodiment, database 120 is stored remotely from PPP device 112 and may be non-centralized. Database 120 may be a database configured to store information used by PPP computing device 112 including, for example, transaction records, as described herein.

Database 120 may include a single database having separated sections or partitions, or may include multiple databases, each being separate from each other. Database 120 may store data received from data sources 130 and generated by PPP computing device 112. For example, database 120 may store weather data, imaging data, trap data, scouting data, grower data, pest pressure prediction data, and/or heat map data, as described in detail herein.

In the example embodiment, client systems 114 may be associated with, for example, a grower, a scouting entity, a pest management entity, and/or any other party capable of using system 100 as described herein. In the example embodiment, at least one of client systems 114 includes a user interface 118. For example, user interface 118 may include a graphical user interface with interactive functionality, such that pest pressure predictions and/or heat maps, transmitted from PPP computing device 112 to client system 114, may be shown in a graphical format. A user of client system 114 may interact with user interface 118 to view, explore, and otherwise interact with the displayed information.

In the example embodiment, PPP computing device 112 receives data from a plurality of data sources 130, and aggregates and analyzes the received data (e.g., using machine learning) to generate pest pressure predictions and/or heat maps, as described in detail herein.

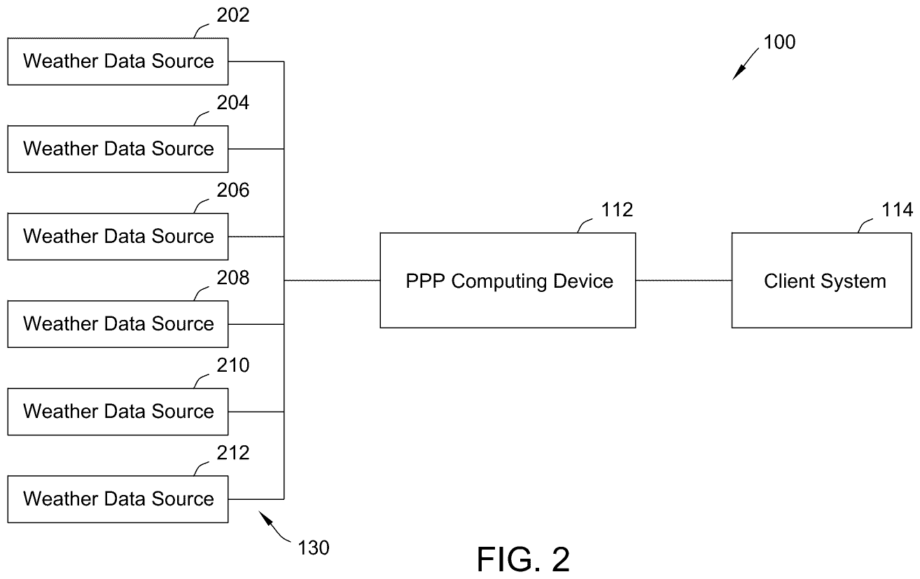

FIG. 2 is a block diagram illustrating data flow through system 100. In the embodiment shown in FIG. 2, data sources 130 include a weather data source 202, an imaging data source 204, a trap data source 206, a scouting data source 208, a grower data source 210, and an another data source 212. Those of skill in the art will appreciate that data sources 130 shown in FIG. 2 are merely examples, and that system 100 may include any suitable number and type of data source. Further, imaging data source 204, trap data source 206, scouting data source 208, and grower data source 210 are examples of sources of historical pest pressure data (as they may include data indicative of a current or past pest pressure). s

Weather data source 202 provides weather data to PPP computing device 112 for use in generating pest pressure predictions. Weather data may include, for example, temperature data (e.g., indicating current and/or past temperatures measured at one or more geographic locations), humidity data (e.g., indicating current and/or past humidity at measured at one or more geographic locations), wind data (e.g., indicating current and/or past wind levels and direction measured at one or more geographic locations), rainfall data (e.g., indicating current and/or past rainfall levels measured at one or more geographic locations), and forecast data (e.g., indicating future weather conditions predicted for one or more geographic locations).

Imaging data source 204 provides image data to PPP computing device 112 for use in generating pest pressure predictions. Image data may include, for example, satellite images and/or drone images acquired of one or more geographic locations.

Trap data source 206 provides trap data to PPP computing device 112 for use in generating pest pressure predictions. Trap data may include, for example, pest counts (e.g., expressed as number of a pest species, density of the pest species, or the like) from at least one pest trap in a geographic location. Further, trap data may include, for example, in the case of insects, pest type (e.g., taxonomic genus, species, variety, etc.) and/or pest developmental stage and gender (e.g., larva, juvenile, adult, male, female, etc.). The pest traps may be, for example, insect traps. Alternatively, the pest traps may be any device capable of determining a pest presence and providing trap data to PPP computing device 112 as described herein. For example, in some embodiments, the pest traps are sensing devices operable to sense an ambient level of spores associated with one or more species of fungi. In such embodiments, the trap data may include, for example, number of spores (representing the pest count), fungus type, fungus developmental stage, etc.

In some embodiments, trap data source 206 is a pest trap that is communicatively coupled to PPP computing device 112 (e.g., over a wireless communication link). Accordingly, in such embodiments, trap data source 206 may be capable of automatically determining a pest count in the pest trap (e.g., using image processing algorithms) and transmitting the determined pest count to PPP computing device.

Scouting data source 208 provides scouting data to PPP computing device 112 for use in generating pest pressure predictions. Scouting data may include any data provided by a human scout that monitors one or more geographic locations. For example, the scouting data may include crop condition, pest counts (e.g., manually counted at a pest trap by the human scout), etc. In some embodiments, scouting data source 208 is one of client systems 114. That is, a scout can both provide scouting data to PPP computing device 112 and view pest pressure prediction data and/or heat map data using the same computing device (e.g., a mobile computing device).

Grower data source 210 provides grower data to PPP computing device 112 for use in generating pest pressure predictions. Grower data may include, for example, field boundary data, crop condition data, etc. Further, similar to scouting data source 208, in some embodiments, grower data source 210 is one of client systems 115. That is, a grower can both provide scouting data to PPP computing device 112 and view pest pressure prediction data and/or heat map data using the same computing device (e.g., a mobile computing device).

Other data source 212 may provide other types of data to PPP computing device 112 that are not available from data sources 202-210. For example, in some embodiments, other data source 212 includes a mapping database that provides mapping data (e.g., topographical maps of one or more geographic locations) to PPP computing device 112.

In the example embodiment, PPP computing device 112 receives data from at least one of data sources 202-212, and aggregates and analyzes that data (e.g., using machine learning) to generate pest pressure prediction data, as described herein. Further, PPP computing device 112 may also aggregate and analyze that data to generate heat map data, as described herein. The pest pressure prediction data and/or heat map data may be transmitted to client system 114 (e.g., for displaying to a user of client system 114).

In some embodiments, data from at least one of data sources 202-210 is automatically pushed to PPP computing device 112 (e.g., without PPP computing device 112 polling or querying data sources 202-210). Further, in some embodiments, PPP computing device 112 polls or queries (e.g., periodically or continuously) at least one of data sources 202-210 to retrieve the associated data.

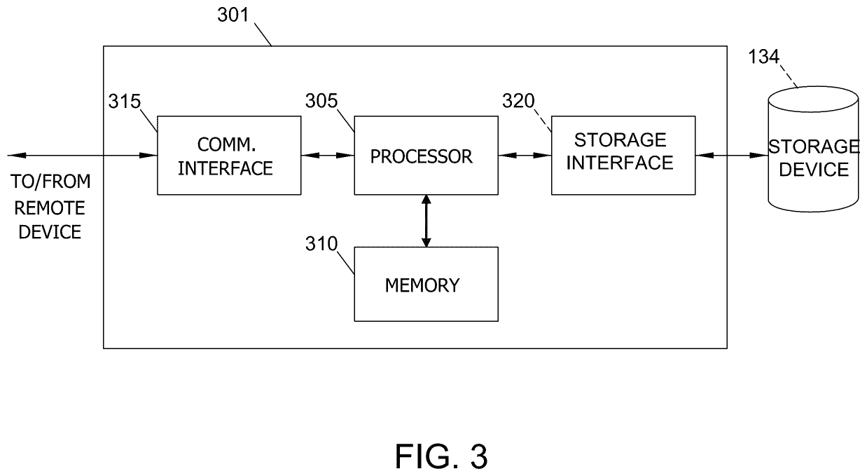

FIG. 3 illustrates an example configuration of a server system 301 such as PPP computing device 112 (shown in FIGS. 1 and 2), in accordance with one example embodiment of the present disclosure. Server system 301 may also include, but is not limited to, database server 116. In the example embodiment, server system 301 generates pest pressures prediction data and heat map data as described herein.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from a client system 114 via the Internet, as illustrated in FIG. 2.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

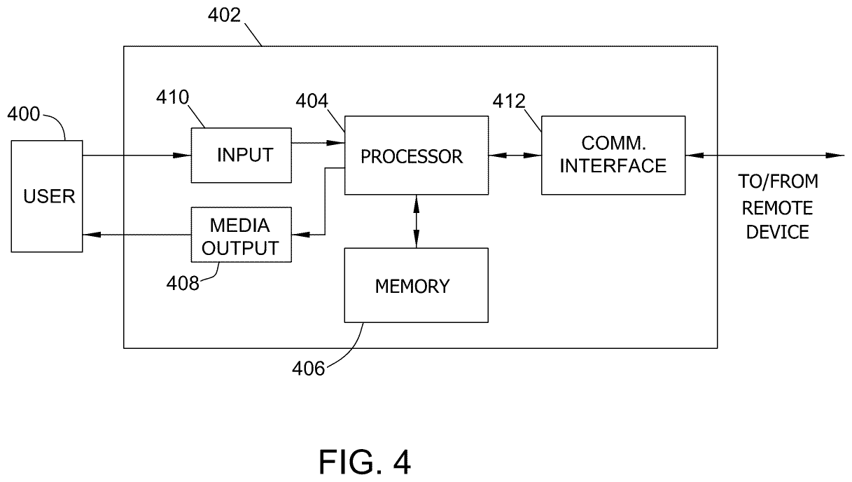

FIG. 4 illustrates an example configuration of a client computing device 402. Client computing device 402 may include, but is not limited to, client systems (“client computing devices”) 114. Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400. Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 301 or a web server. Communication interface 412 may include, for example, a wired or wireless network adapter or a wireless data transceiver for use with a mobile phone network (e.g., Global System for Mobile communications (GSM), 3G, 4G, 5G, or Bluetooth) or other mobile data network (e.g., Worldwide Interoperability for Microwave Access (WIMAX)).

Stored in memory area 406 are, for example, computer-readable instructions for providing a user interface to user 400 via media output component 408 and, optionally, receiving and processing input from input device 410. A user interface may include, among other possibilities, a web browser and client application. Web browsers enable users 400 to display and interact with media and other information typically embedded on a web page or a website from a web server. A client application allows users 400 to interact with a server application. The user interface, via one or both of a web browser and a client application, facilitates display of pest pressure information provided by PPP computing device 112. The client application may be capable of operating in both an online mode (in which the client application is in communication with PPP computing device 112) and an offline mode (in which the client application is not in communication with PPP computing device 112).

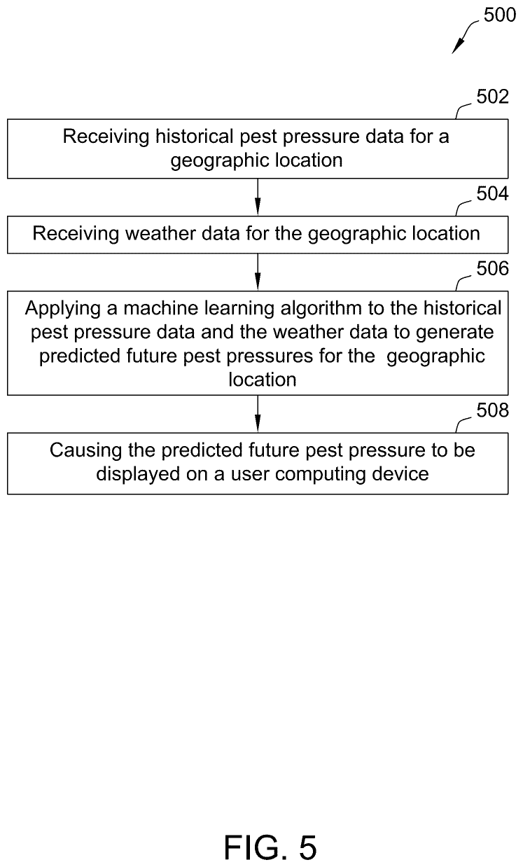

FIG. 5 is a flow diagram of an example method 500 for generating pest pressure data. Method 500 may be implemented, for example, using PPP computing device 112.

Method 500 includes receiving 502 historical pest pressure data for a geographic location. The historical pest pressure data may be received from, for example, imaging data source 204, trap data source 206, scouting data source 208, and/or grower data source 210 (all shown in FIG. 2). In the example embodiment the historical pest pressure data includes current and past pest pressure data. Further, PPP computing device 112 may analyze the received historical pest pressure data to generate additional data. For example, from the received historical pest pressure data, PPP computing device 112 may determine, for a number of different pest pressure levels (e.g., defined by suitable upper and lower thresholds), a number of traps at each level. Further, PPP computing device 112 may determine average pest pressures across a number of traps and/or across at least a portion of the geographic location. This additional data may be used in identifying correlations and predicting future pest pressures, as described herein.

Method 500 further includes receiving 504 weather data 502 for the geographic location. In the example embodiment, the weather data includes both current and historical weather conditions for the geographic location. Further, in some embodiments, the weather data may include predicted future weather conditions for the geographic location. The weather data may be received 504 from, for example, weather data source 202 (shown in FIG. 2).

In some embodiments, method includes identifying at least one geospatial feature within the geographic location or proximate the geographic location.

As used herein, a ‘geospatial feature’ refers to a geographic feature or structure that may have an impact on pest pressure. For example, a geographic feature may include a body of water (e.g., a river, a stream, a lake, etc.), an elevation feature (e.g., a mountain, a hill, a canyon, etc.), a transportation route (e.g., a road, a railroad track, etc.), a farm location, or a factory (e.g., a cotton factory).

In one embodiment, the at least geospatial feature is identified from existing map data. For example, PPP computing device 112 may retrieve previously generated maps (e.g., topographical maps, elevation maps, road maps, surveys, etc.) from a map data source (such as other data source 212 (shown in FIG. 2)), the previously generated maps demarcating the one or more geospatial features.

In another embodiment, PPP computing device 112 identifies the one or more geospatial features by analyzing received image data. For example, PPP computing device 112 may apply raster processing to the image data to generate a digital elevation map, where each pixel (or other similar subdivision) of the digital elevation map is associated with an elevation value. Then, based on the elevation values, PPP computing device 112 identifies the one or more geospatial features from the digital elevation map. For example, elevation features and/or bodies of water may be identified using such techniques.

Method 500 further includes applying 506 a machine learning algorithm to the historical pest pressure data and the weather data to generated predicted future pest pressures for the geographic location. In some embodiments, the predicted future pest pressures may be generated by identifying a correlation between pest pressure and the at least one geospatial feature. For example, in some embodiments, PPP computing device 112 may determine, by applying 506 the machine learning algorithm, that pest pressure (e.g., at the location of a pest trap) varies based on a distance from the at least one identified geospatial feature. For example, PPP computing device 112 may determine that pest pressure is higher at locations proximate to a body of water (e.g., due to increased pest levels at the body of water). In another example, PPP computing device 112 may determine that pest pressure is higher at locations proximate a transportation route (e.g., due to increased pest levels resulting from material transported along the transportation route). In yet another example, PPP computing device 112 may determine that pest pressure is higher at locations proximate a factory (e.g., due to increased pest levels resulting from materials processed at the factory). In yet other examples, PPP computing device 112 may determine that pest pressure is reduced at locations proximate the at least one identified geospatial feature.

Those of skill in the will appreciate that the machine learning algorithm is capable of detecting complex interactions between those different types of data that may not be ascertainable by a human analyst. For example, non-distance-based correlations between the at least one identified geospatial feature and pest pressure may be identified in some embodiments.

In one or more example embodiments, applying 506 the machine learning algorithm may include determining one or more predicted future pest pressures based on a model (e.g. a machine learning model, a pest lifecycle model). Further, in some embodiments, pest pressure for a first pest may be correlated to pest pressure for a second, different pest, and that correlation may be detected using PPP computing device 112. For example, the at least one geospatial feature is a particular field having a known high pest pressure for the second pest. Using the systems and methods described herein, PPP computing device 112 may determine that locations proximate the particular field generally have a high pest pressure for the first pest, which correlates to the pest pressure level of the second pest in the particular field. These “inter-pest” correlations may be complex relationships that are identifiable by PPP computing device 112, but that would not be identifiable by a human analyst. Similarly, “inter-crop” correlations may be identified by PPP computing device 112 between nearby geographic locations.

In some embodiment, PPP computing device 112 may utilize spray timer models, pest lifecycle models, etc. to generate the predicted future pest pressures. Those of skill in the art will appreciate that any suitable types of data may be incorporated to generate predicted future pest pressures. For example, previously planted crop data, neighboring farm data, field water level data, and/or soil type data may be considered when predicting future pest pressures.

In the example embodiment, the predicted future pest pressures are generated using an enhanced growing degree day (GDD) model. The enhanced GDD model leverages high fidelity weather forecast data, historical pest pressure data, and sophisticated modeling techniques to determine predicted future pest pressures. For example, developmental stages of a pest of interest (e.g., an insect, or a fungus) may be governed by an ambient temperature, and the model may predict developmental stages of the pest based on heat accumulation (e.g., determined from temperature data). Notably, in the embodiments described herein, the predicted future pest pressures include predicted peak pressures, and estimated times until the predicted peak pressures will be reached (also referred to herein as peak pressure estimated arrival times).

Method 500 further includes causing 508 the predicted future pest pressure to be displayed on a user computing device, such as client system 114 (shown in FIGS. 1 and 2). For example, the predicted future pest pressures may be transmitted to the user computing device to cause the user computing device to present the predicted future pest pressures in a textual, graphical, and/or audio format, or any other suitable format. As described below in detail, in some embodiments, the peak pressure estimated arrival times are displayed on the user computing device.

From the generated predicted future pest pressures, in some embodiments, the systems and methods described herein may also be used to generate (e.g., using machine learning) a treatment recommendation for the geographic location to address the predicted future pest pressures. For example, with an accurate prediction of future pest pressures in place, PPP computing device 112 may automatically generate a treatment plan for the geographic location to mitigate future levels of high pest pressure. The treatment plan may specify, for example, one or more substances (e.g., pesticides, fertilizers, etc.) and specific times when those one or more substances should be applied (e.g., daily, weekly etc.). Alternatively, the treatment plan may include other data to facilitate improving agricultural performance in view of predicted future pest pressures. The treatment plan may be generated, for example, based on the predicted peak pressures and peak pressure estimated arrival times.

Further, in some embodiments, the predicted future pest pressures are used (e.g., by PPP computing device 112) to control additional systems. In one embodiment, a system for monitoring pest pressure (e.g., a system including pest traps) may be controlled based on the predicted future pest pressures. For example, a reporting frequency and/or type of trap data reported by one or more pest traps may be modified based on the predicted future pest pressures. In another example, spraying equipment (e.g., for spraying pesticides) or other agricultural equipment may be controlled based on the predicted future pest pressures. These systems may be controlled, for example, based on the predicted peak pressures and peak pressure estimated arrival times.

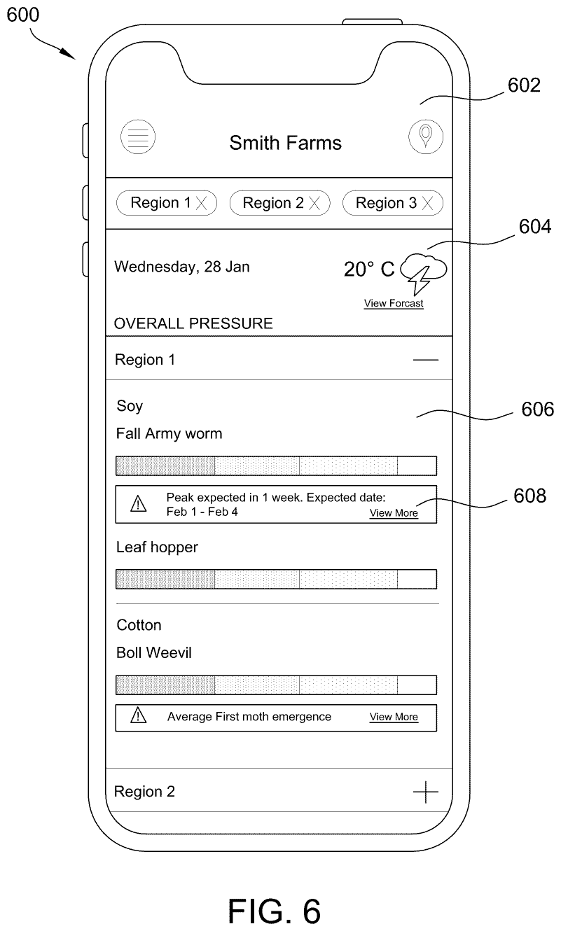

FIG. 6 is a first screenshot 600 of a user interface that may be displayed on a computing device, such as client system 114 (shown in FIGS. 1 and 2). The computing device may be, for example, a mobile computing device.

First screenshot 600 shows one embodiment of a home screen 602. Home screen 602 includes current weather information 604, as well as pest pressure information 606 for one or more regions associated with a given farm (e.g., “Smith Farms” here). Pest pressure information 606 may include past, current, and/or predicted future pest pressure information. Further, as shown in FIG. 6, pest pressure information 606 is shown for different crops (e.g., soy and cotton), and is shown for different pests (e.g., fall armyworm, leafhopper, and boll weevil).

Notably, pest pressure information 606 includes peak pressure estimated arrival time information 608. Here, for example, peak pressure estimated arrival time information 608 is represented as a text box that indicates the peak pest pressure for foil armyworms in the soy crop of Region 1 is expected in one week. By selecting a link 610 included in peak pressure estimated arrival time 608, the user can view additional information associated with peak pressure estimated arrival time 608, as described in detail herein.

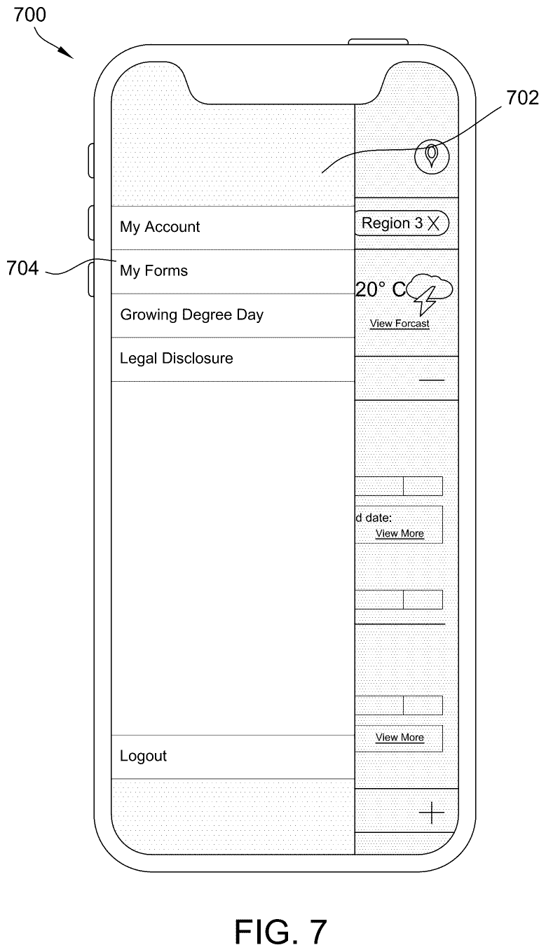

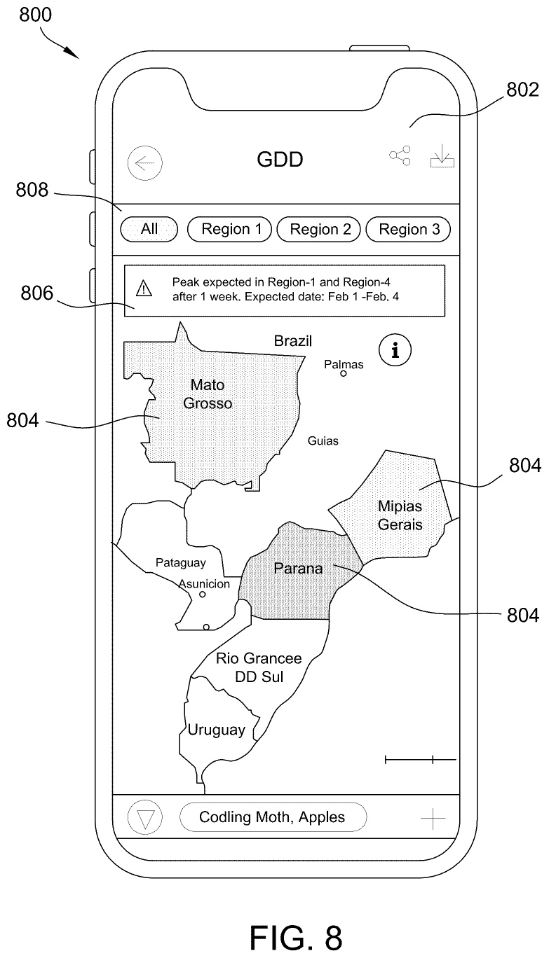

FIG. 7 is a second screenshot 700 of a user interface that may be displayed on a computing device, such as client system 114 (shown in FIGS. 1 and 2). Second screenshot 700 shows one embodiment of a menu screen 702. Menu screen 702 includes multiple selectable tabs 704 (e.g., an account date, a farms tab, a growing degree days tab, and a legal tab). Selecting the farms tab, for example, may cause the user interface to display home screen 602 (shown in FIG. 6). Selecting the growing degrees day tab may cause the user interface to display a growing degree day screen overview screen (as shown in FIG. 8).

FIG. 8 is a third screenshot 800 of a user interface that may be displayed on a computing device, such as client system 114 (shown in FIGS. 1 and 2). Third screenshot 800 shows one embodiment of a GDD overview screen 802. GDD overview screen 802 shows a plurality of different geographic regions 804 and may be displayed, for example, to a user responsible for geographic regions 804. In this embodiment, geographic regions 804 are each states. However, those of skill in the art will appreciate that geographic regions 804 may be each be countries, cities, counties, farms, fields, and/or any other suitable location.

In some embodiments, a particular entity (e.g., a company or grower) may only be responsible for one region, and thus, may only have access to data for that region. For that type of entity, the user interface may initially display a GDD region-specific screen (described in detail below) instead of GDD overview screen 802.

GDD overview screen 802 includes a peak pressure estimated arrival time 806. In this embodiment, peak pressure estimated arrival time information 806 is a text box that indicates when peak pressure is expected for at least some of geographic regions 804. GDD overview screen 802 also includes a region selection section 808. As shown in FIG. 8, all geographic regions 804 are currently selected. If a user wishes to view a particular geographic region 804, they can select that region 804 in region selection section.

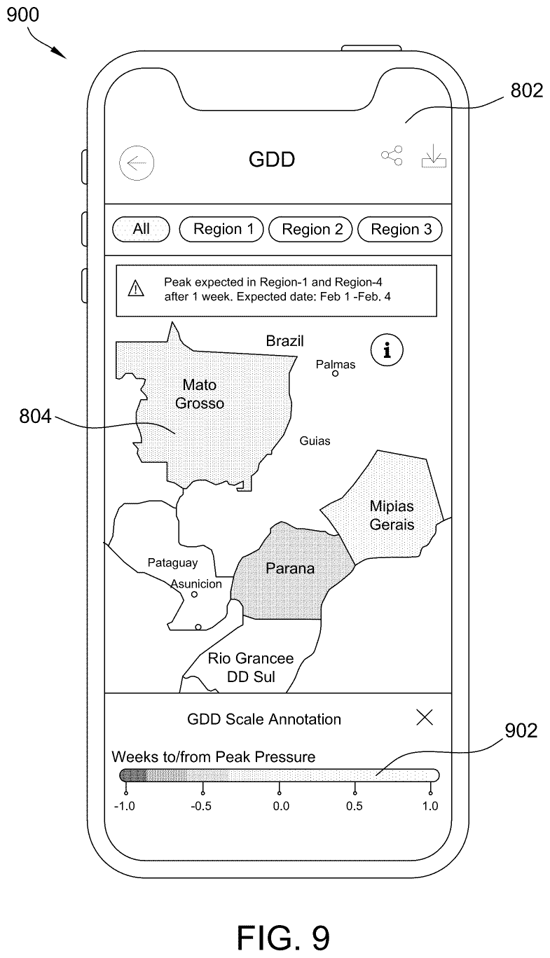

FIG. 9 is a fourth screenshot 900 of a user interface that may be displayed on a computing device, such as client system 114 (shown in FIGS. 1 and 2). Fourth screenshot 900 shows GDD overview screen 802 with a peak pressure estimated arrival time scale 902. Specifically, as shown in FIGS. 8 and 9, geographic regions 804 are color-coded based on their associated peak pressure estimated arrival times. Peak pressure estimated arrival time scale 902 provides the user with an explanation of the color-coding.

For example, peak pressure estimated arrival time scale 902 is a continuous scale that shows how the displayed color varies based on how many weeks until the expected peak pest pressure. A negative amount of weeks would indicate that the expected peak pest pressure has already occurred. Those of skill in the art will appreciate that peak pressure estimated arrival time scale 902 is an example, and that many different suitable scales and/or legends may be used to provide the user with an explanation of the color-coding.

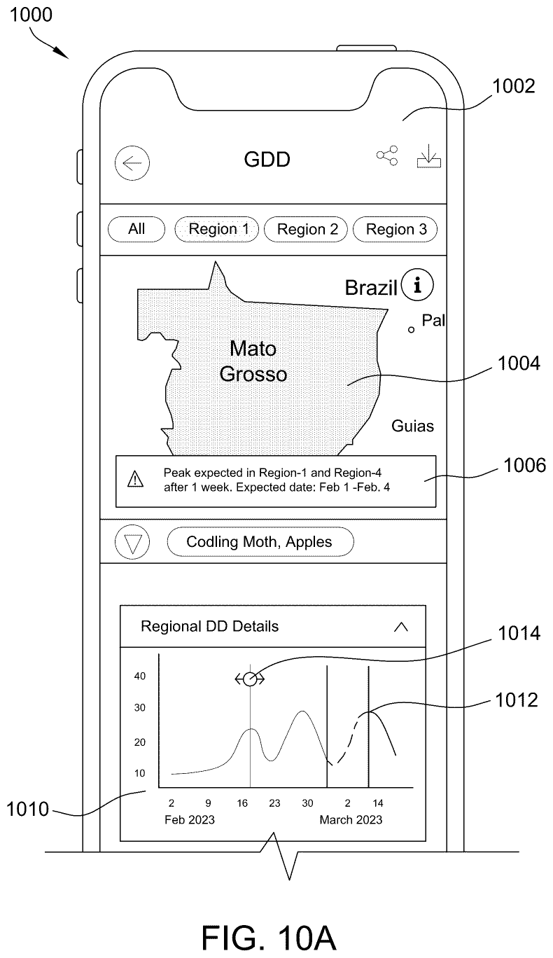

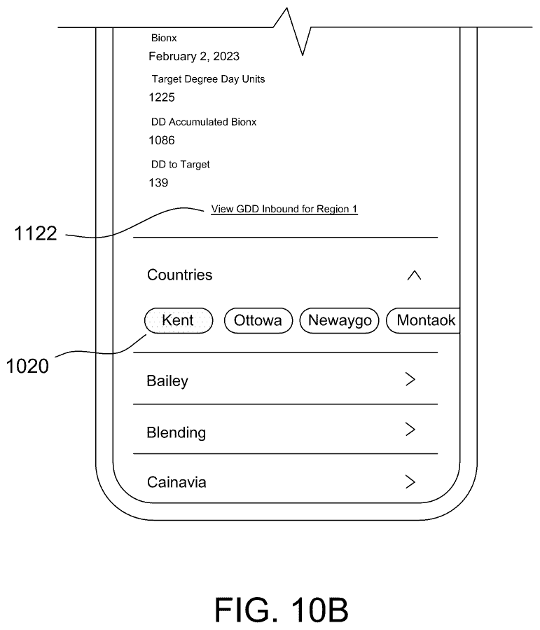

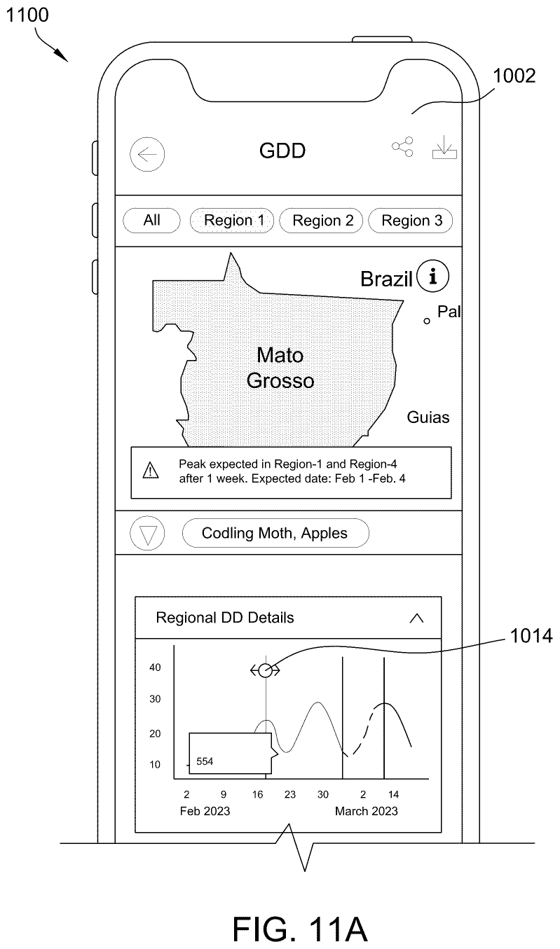

FIGS. 10A and 10B are a fifth screenshot 1000 of a user interface that may be displayed on a computing device, such as client system 114 (shown in FIGS. 1 and 2). Fifth screenshot 1000 shows a GDD region-specific screen 1002. GDD region-specific screen 1002 is displayed in response to a user selecting a particular geographic region 804 on GDD overview screen 802 (e.g., using region selection section 808). Accordingly, GDD region-specific screen 1002 displays a selected geographic region 1004, and also displays peak pressure estimated arrival time information 1006 (e.g., as a text box) for selected geographic region 1004.

Notably, GDD region-specific screen 1002 also displays more granular information (relative to GDD overview screen 802) regarding the predicted future pest pressures (including the predicted peak pest pressure) for selected geographic region 1004.

For example, GDD region-specific screen 1002 includes a graph 1010 that shows predicted pest pressure over time, including a predicted peak pest pressure 1012. Further, graph 1010 includes a slider 1014. By moving slider 1012 from left to right (e.g., by clicking and dragging slider 1012), user can select a particular day on graph 1010. As a user selects a particular day, detailed degree day information for the selected day is dynamically displayed.

GDD region-specific screen 1002 also includes a sub-region selection 1020 that allows the users to select particular sub-regions within the selected geographic region 1004 (and display additional pest pressure information for those sub-regions). Here, the sub-regions are counties within the selected state. Again, those of skill in the art will appreciate that sub-regions may be any suitable location.

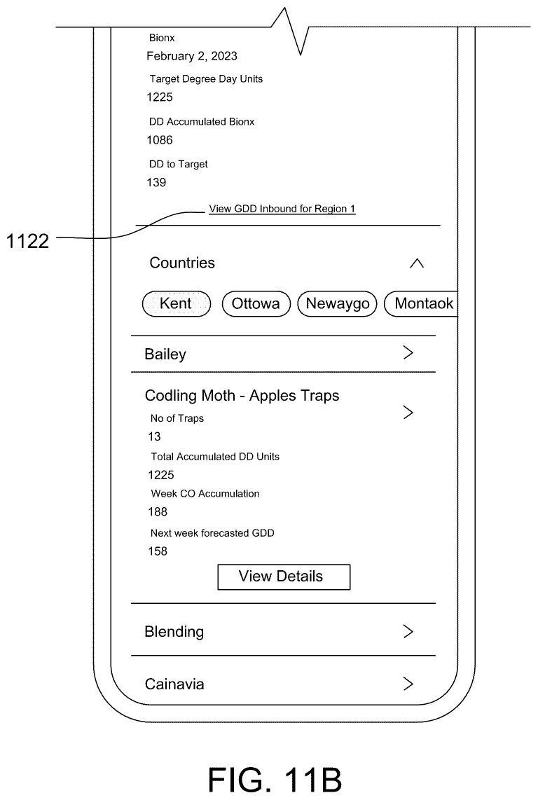

FIGS. 11A and 11B are a sixth screenshot 1100 of a user interface that may be displayed on a computing device, such as client system 114 (shown in FIGS. 1 and 2). Sixth screenshot 1100 shows GDD region-specific screen 1002 where a user has manipulated slider 1014 to a different day (relative to FIG. 10). Further, in sixth screenshot 1100, the user has selected a particular city (“Bailey”) within a particular county (“Kent”), which causes GDD region-specific screen 1002 to display pest pressure information (including predicted pest pressure information) for the selected city and county. Accordingly, GDD region-specific screen 1002 allows a user to quick and easily drill down into relevant pest pressure information. Further, that information is presented to the user in a straight-forward and intuitive manner.

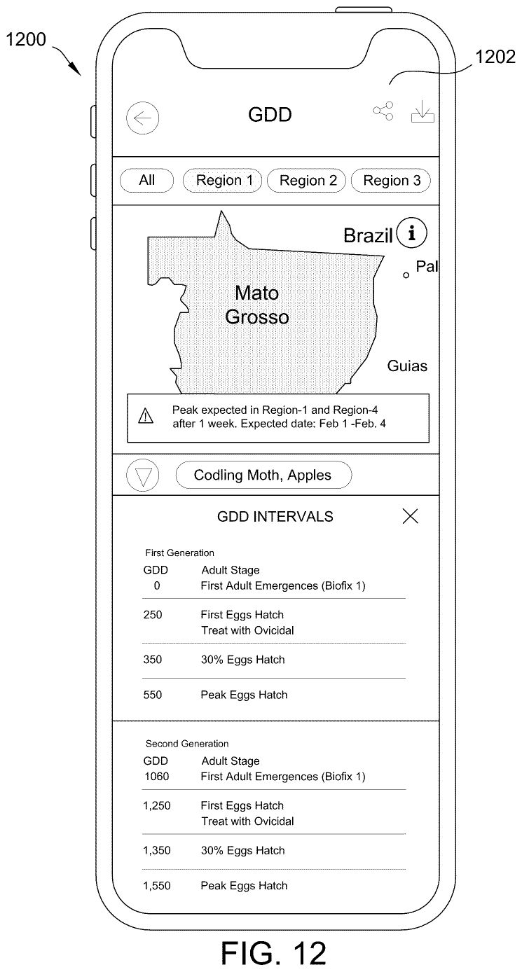

FIG. 12 is a seventh screenshot 1200 of a user interface that may be displayed on a computing device, such as client system 114 (shown in FIGS. 1 and 2). Seventh screenshot 1200 shows a GDD intervals screen 1202 that may be displayed, for example, in response to a user selecting a GDD interval information link 1122 (shown in FIGS. 10 and 11). GDD intervals screen 1202 displays detailed GDD information for the pest(s) associated with selected geographic region 1004.

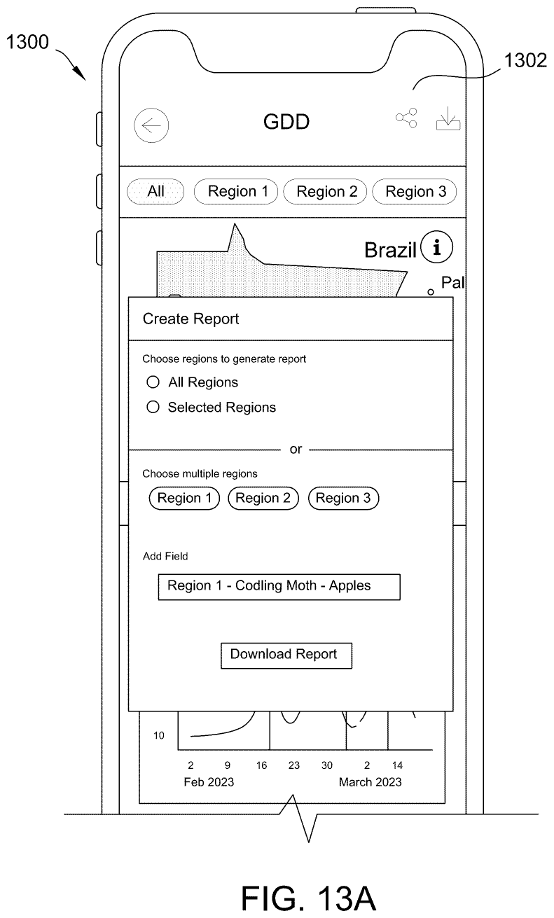

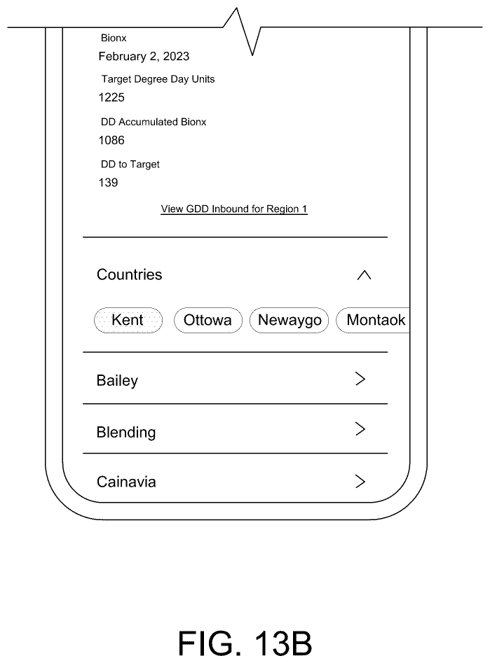

FIGS. 13A and 13B are an eighth screenshot 1300 of a user interface that may be displayed on a computing device, such as client system 114 (shown in FIGS. 1 and 2). Eighth screenshot 1300 shows a report generation screen 1302 that may be displayed, for example, in response to a user selection made on GDD overview screen 802 and/or GDD region-specific screen 1002. Report generation screen 1302 enables a user to generate a report that includes pest pressure information (including predicted pest pressures) for one or more of geographic regions 804. The report can be downloaded to the computing device and/or shared with other users (e.g., via email).

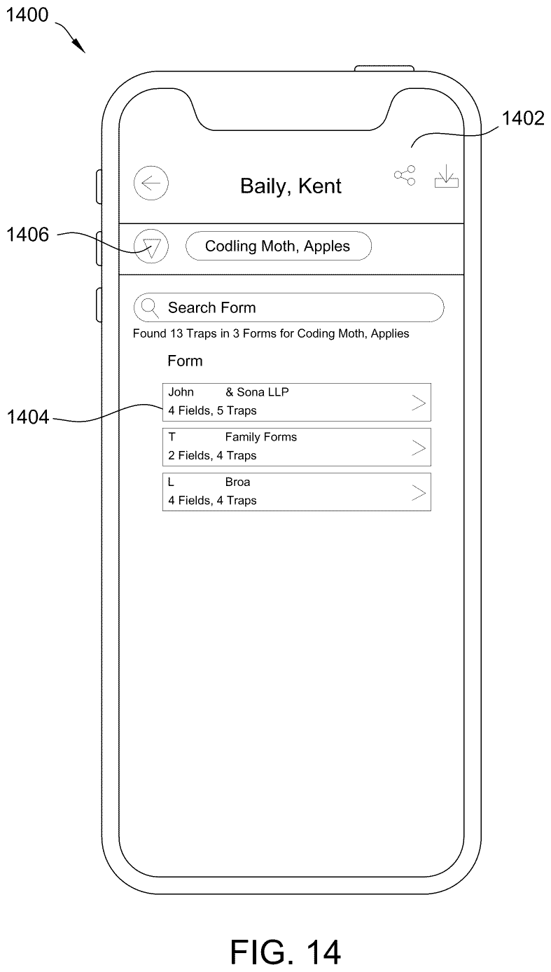

FIG. 14 is a ninth screenshot 1400 of a user interface that may be displayed on a computing device, such as client system 114 (shown in FIGS. 1 and 2). Ninth screenshot 1400 is an city overview screen 1402 that displays a plurality of farms 1404 associated with a selected city (here, the city of Baily in the county of Kent). By selecting one of the farms 1404, detailed information for the selected farm is displayed (as described below). City overview screen 1404 also includes a filter button 1406. Selecting the filter button 1406 enables a user to select a particular pest (e.g., codling moth) and/or crop (e.g., apples) for which information is desired. Filter button 1406 may be included in other screens of the user interface (e.g., GDD overview screen 802).

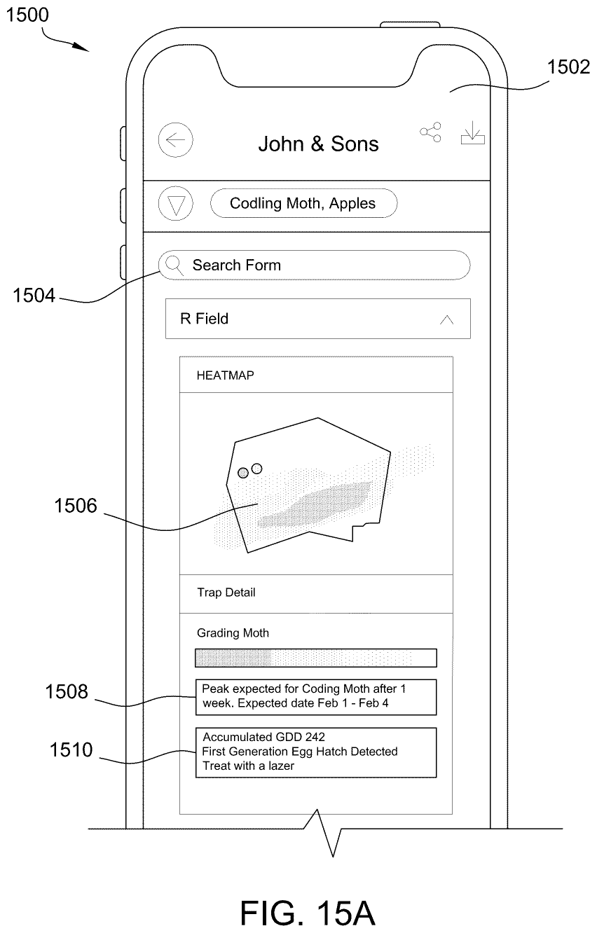

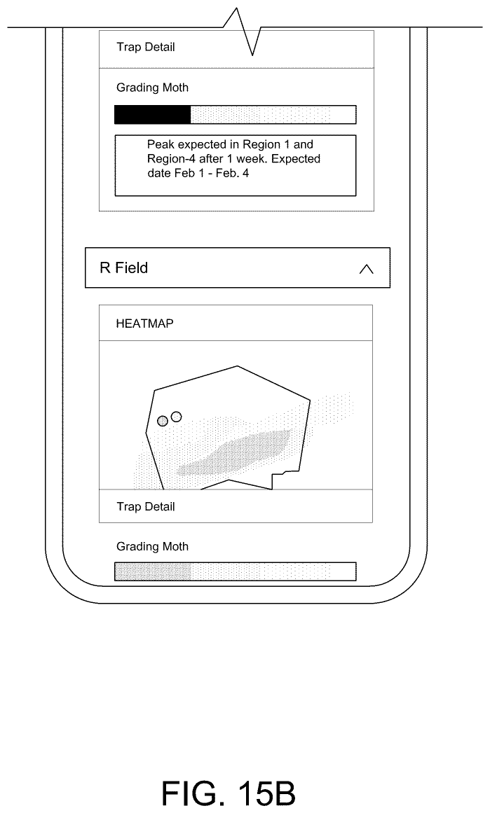

FIGS. 15A and 15B are a tenth screenshot 1500 of a user interface that may be displayed on a computing device, such as client system 114 (shown in FIGS. 1 and 2). Tenth screenshot 1500 is a farm overview screen 1502 that displays pest pressure information for a particular farm (e.g., selected from farms 1404 displayed on city overview screen 1402). For the particular farm, pest pressure information for one or more fields 1504 is displayed. The pest pressure information for a field 1504 may include, for example, a heat map 1506 showing current and/or predicted pest pressures, a peak pressure estimated arrival time 1508 (e.g., as text box), and/or GDD information 1510.

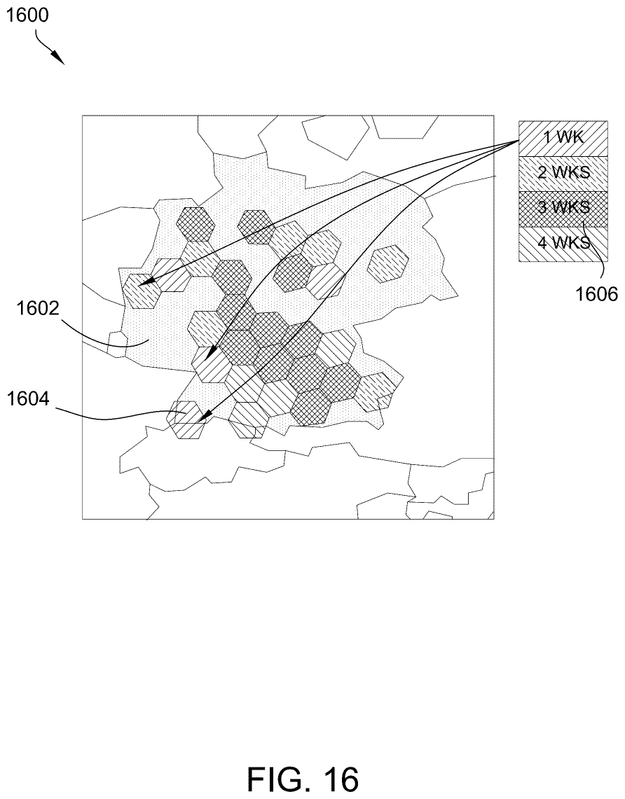

FIG. 16 is one embodiment of a predicted peak pressure map 1600. Predicted peak pressure map 1600 may be displayed as part of a user interface on a computing device, such as client system 114 (shown in FIGS. 1 and 2). For example, predicted peak pressure map 1600 may be included in GDD overview screen 802.

As shown in FIG. 16, predicted peak pressure map 1600 shows a geographic region 1602 subdivided into a plurality of sectors 1604. Further, each sector 1604 is color-coded according to the peak pest pressure estimated arrival time for that sector. A key 1606 explains how many weeks until estimated peak pressure correspond to each color.

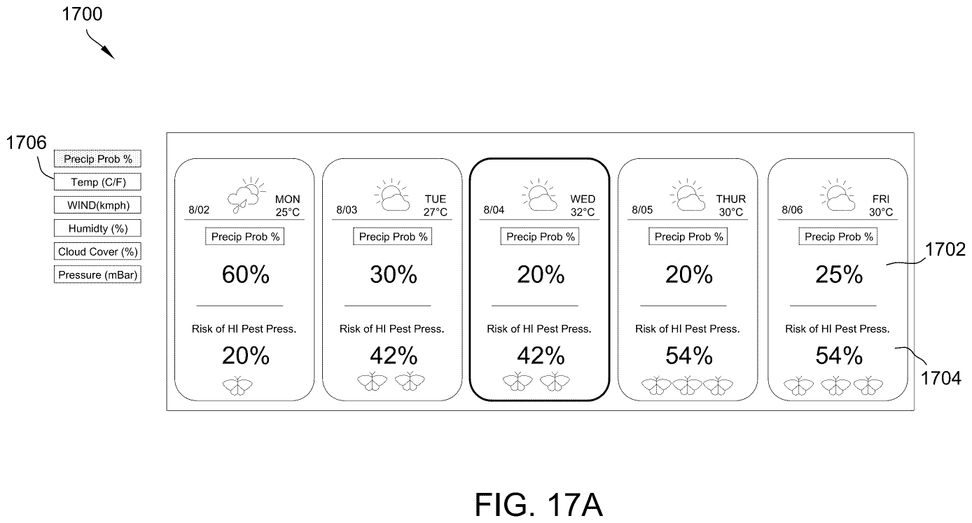

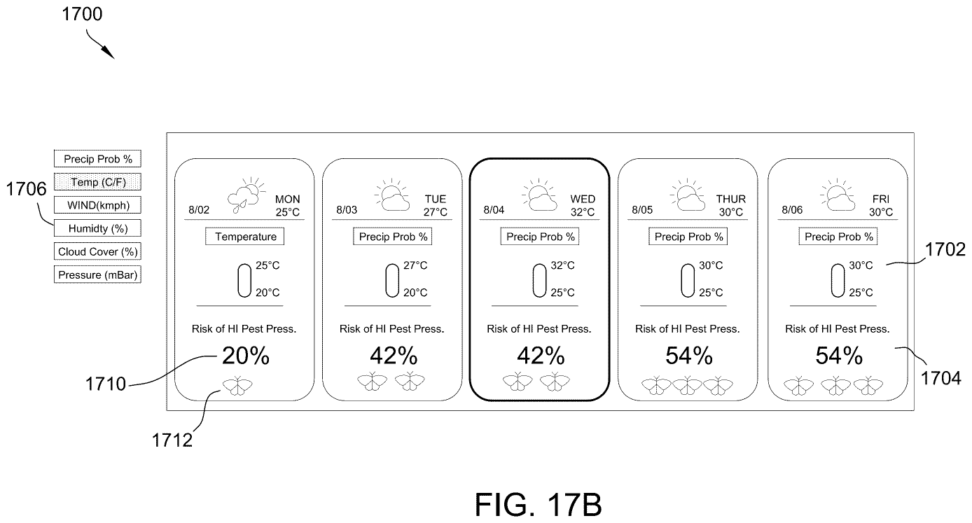

FIGS. 17A and 17B are embodiments of a weather and pest pressure display 1700. Weather and pest pressure display 1700 may be displayed as part of a user interface on a computing device, such as client system 114 (shown in FIGS. 1 and 2).

In this embodiment, weather and pest pressure display 1700 displays weather information 1702 and pest pressure information 1704 for a given week. A user can select what weather information is displayed using a weather parameter selection section 1706. In FIG. 17A, the user has chosen to display the probability of precipitation as weather information 1702. In FIG. 17B, the user has chosen to display the temperature as weather information 1702.

In this embodiment, pest pressure information 1704 includes a quantified risk of high pest pressure 1710 and a graphical risk of high pest pressure 1712. Quantified risk of high pest pressure 1710 is an actual percentage. In contrast, graphical risk of high pest pressure 1712 intuitively indicates the risk of high pest pressure to a user. For example, in this embodiment, a high predicted pest pressure (e.g., over a 50% risk) is depicted as three pest icons, a moderate predicted pest pressure is depicted as two pest insects, and a low predicted pest pressure is depicted as one pest icon. Those of skill in the art will appreciate that FIGS. 17A and 17B are only examples, and that weather information 1702 and pest pressure information 1704 may be displayed in any suitable matter.

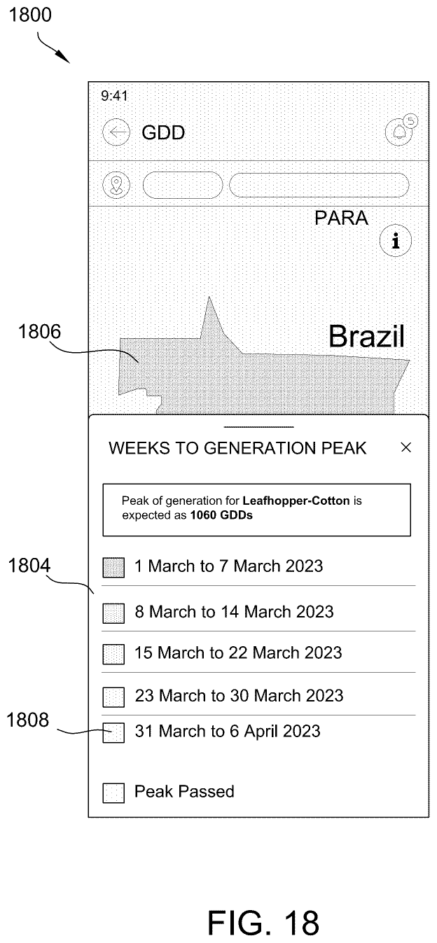

FIG. 18 is an alternative embodiment of a GDD overview screen 1802 that may be displayed on a computing device, such as client system 114 (shown in FIGS. 1 and 2). GDD overview screen 1802 includes a peak pressure estimated arrival legend 1804. Specifically, as shown in FIG. 18, geographic regions 1806 are color-coded based on their associated peak pressure estimated arrival times. Peak pressure estimated arrival legend 1804 provides the user with an explanation of the color-coding.

For example, peak pressure estimated arrival legend 1804 includes an arrangement of colored boxes 1808 that shows how the displayed color varies based on how many weeks until the expected peak pest pressure. Those of skill in the art will appreciate that peak pressure estimated arrival legend 1804 is an example, and that many different suitable scales and/or legends may be used to provide the user with an explanation of the color-coding.

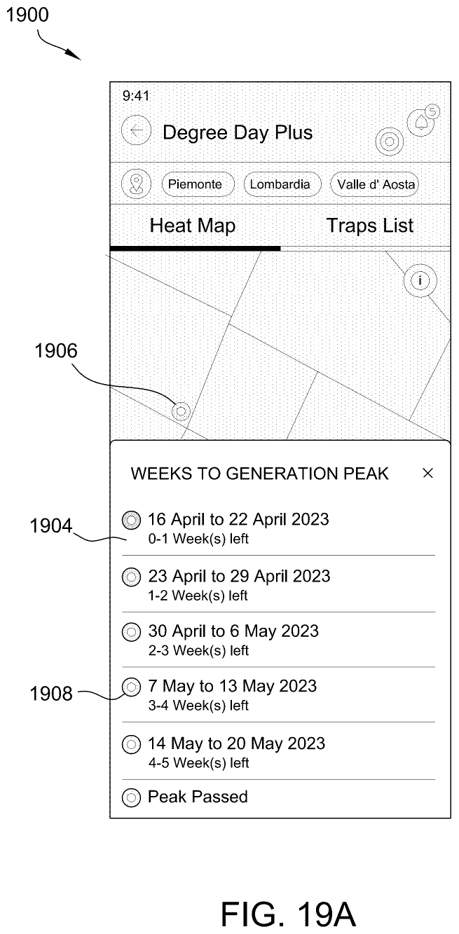

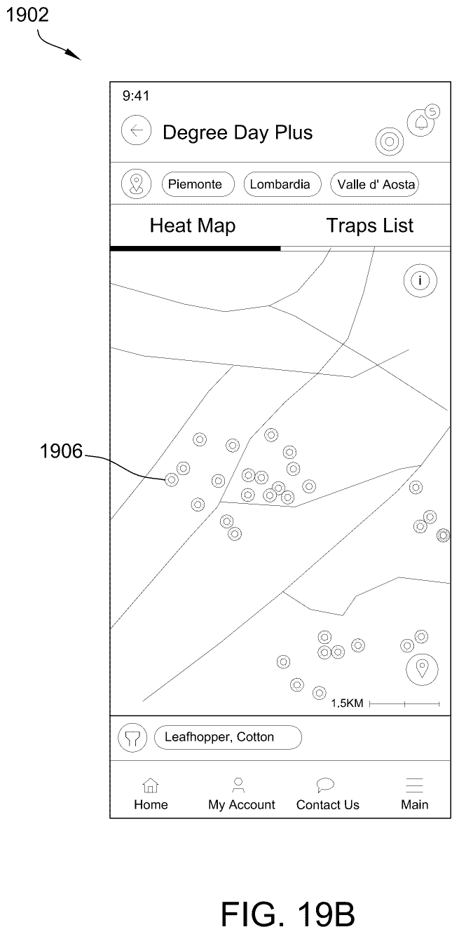

FIGS. 19A and 19B are an alternative embodiment of a GDD overview screen 1902 that may be displayed on a computing device, such as client system 114 (shown in FIGS. 1 and 2). GDD overview screen 1902 includes a peak pressure estimated arrival legend 1904. Specifically, as shown in FIGS. 19A and 19B, geographic regions 1906 are color-coded based on their associated peak pressure estimated arrival times. Peak pressure estimated arrival legend 1904 provides the user with an explanation of the color-coding.

For example, peak pressure estimated arrival legend 1904 includes an arrangement of colored circles 1908 that shows how the displayed color varies based on how many weeks until the expected peak pest pressure. Those of skill in the art will appreciate that peak pressure estimated arrival legend 1904 is an example, and that many different suitable scales and/or legends may be used to provide the user with an explanation of the color-coding.

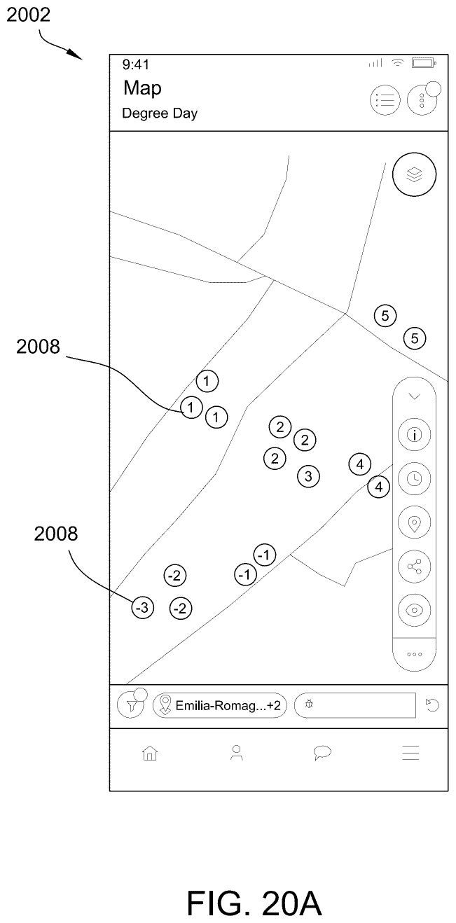

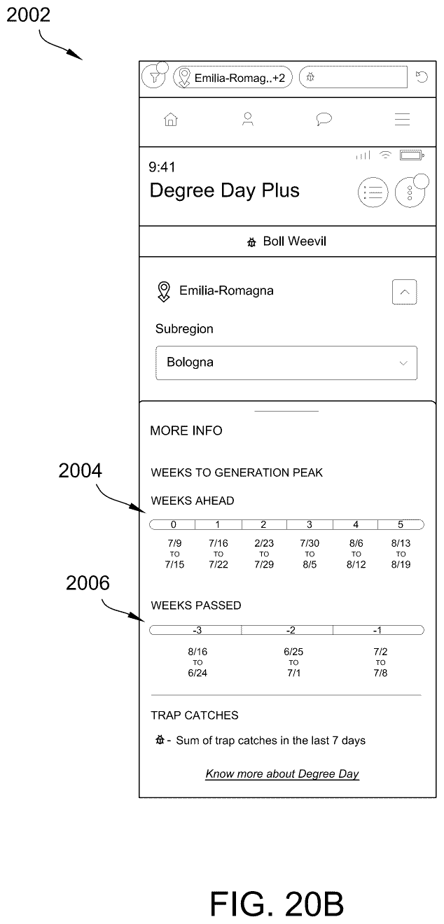

In some embodiments, data regarding past peak pest pressure (i.e., pest pressure peaks that have already occurred) may be displayed to a user. For example, FIGS. 20A and 20B are an alternative embodiment of a GDD overview screen 2002 that may be displayed on a computing device, such as client system 114 (shown in FIGS. 1 and 2). GDD overview screen 2002 includes a peak pressure estimated arrival legend 2004 as well as a past peak pressure legend 2006. Further, as shown in FIGS. 20A and 20B, geographic regions 2008 are color-coded (or otherwise indicated) based on their associated peak pressure estimated arrival times as well as their past peak pressure times. Peak pressure estimated arrival legend 2004 and past peak pressure legend 2006 provide the user with an explanation of the color-coding. This allows the user to quickly and easily understand both past and future pest pressure patterns.

In the example shown in FIGS. 20A and 20B, geographic regions 2008 are displayed in association with a number that indicates (e.g., in weeks or days) how much time until the estimated peak pressure or how much time since the past peak pressure. In this example, a positive number (e.g., 1, 2, 3, or 4) indicates how many weeks until peak pressure is expected in geographic region 2008, and a negative number (e.g., −1, −2, or −3) indicates how long ago the peak pressure occurred in geographic region 2008.

At least one of the technical problems addressed by this system includes: i) inability to accurately monitor pest pressure; ii) inability to accurately predict future pest pressure and peak pest pressure; and iii) inability to communicate pest pressure information to a user in a comprehensive, straightforward manner.

The technical effects provided by the embodiments described herein include at least i) monitoring pest pressure in real-time; ii) accurately predicting future pest pressure, including peak pest pressure, using machine learning; iii) controlling other systems or equipment based on predicted future pest pressures and peak pest pressures; and iv) generating comprehensive displays illustrating pest pressure information.

Further, a technical effect of the systems and processes described herein is achieved by performing at least one of the following steps: i) receiving historical pest pressure data for a geographic location, the historical pest pressure data including current and past pest pressure data for the geographic location; ii) receiving weather data for the geographic location, the weather data including current and historical weather conditions for the geographic location; iii) applying a machine learning algorithm to the historical pest pressure data and the weather data to generate predicted future pest pressure data for the geographic location; iv) determining, from the predicted future pest pressure data, for each of a plurality of geographic regions within the geographic location, associated predicted pest pressure values, an associated predicted peak pest pressure, and an associated peak pressure estimated arrival time; v) causing a computing device to display the plurality of geographic regions, wherein each geographic region is displayed in a color corresponding to the peak pressure estimated arrival time associated with that region; and vi) causing, in response to a user input on the computing device that selects a particular geographic region of the plurality of geographic regions, the user computing device to display the particular geographic region in association with a graph that indicates the predicted pressure values for that particular geographic region over time, and that indicates when the predicted peak pest pressure for that particular geographic region is expected to occur.

A processor or a processing element in the embodiments described herein may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to analyzing trap data, weather data, image data, geospatial (e.g., using one or more models) to predict future pest pressure.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A pest pressure prediction computing device comprising:
a memory; and
a processor communicatively coupled to the memory, the processor programmed to:
receive historical pest pressure data for a geographic location, the historical pest pressure data including current and past pest pressure data for the geographic location;
receive weather data for the geographic location, the weather data including current and historical weather conditions for the geographic location;
apply a machine learning algorithm to the historical pest pressure data and the weather data to generate predicted future pest pressure data for the geographic location;
determine, from the predicted future pest pressure data, for each of a plurality of geographic regions within the geographic location, associated predicted pest pressure values, an associated predicted peak pest pressure, and an associated peak pressure estimated arrival time;
cause a computing device to display the plurality of geographic regions, wherein each geographic region is displayed in a color corresponding to the peak pressure estimated arrival time associated with that region; and
cause, in response to a user input on the computing device that selects a particular geographic region of the plurality of geographic regions, the user computing device to display the particular geographic region in association with a graph that indicates the predicted pressure values for that particular geographic region over time, and that indicates when the predicted peak pest pressure for that particular geographic region is expected to occur.

2. The pest pressure prediction computing device of claim 1, wherein the processor is further programmed to cause the computing device to display a peak pressure estimated arrival time scale in association with the plurality of geographic regions.

3. The pest pressure computing device of claim 1, wherein the graph includes a movable slider.

4. The pest pressure computing device of claim 3, wherein the processor is further programmed to cause the computing device to dynamically display degree day information based on a position of the moveable slider.

5. The pest pressure computing device of claim 1, wherein the processor is further programmed to cause the computing device to display predicted pest pressure levels for sub-regions of the particular geographic region.

6. The pest pressure computing device of claim 1, wherein the processor is further programmed to cause the computing device to display, for at least one additional geographic region, an indication of how long it has been since a past peak pest pressure occurred.

7. The pest pressure computing device of claim 1, wherein the processor is further programmed to, in response to a user selection, cause the computing device to display growing degree days intervals for a pest associated with the particular geographic region.

8. A method for generating and displaying pest pressure predication data, the method implemented using a pest pressure prediction computing device including a memory communicatively coupled to a processor, the method comprising:
receiving historical pest pressure data for a geographic location, the historical pest pressure data including current and past pest pressure data for the geographic location;
receiving weather data for the geographic location, the weather data including current and historical weather conditions for the geographic location;
applying a machine learning algorithm to the historical pest pressure data and the weather data to generate predicted future pest pressure data for the geographic location;
determining, from the predicted future pest pressure data, for each of a plurality of geographic regions within the geographic location, associated predicted pest pressure values, an associated predicted peak pest pressure, and an associated peak pressure estimated arrival time;
causing a computing device to display the plurality of geographic regions, wherein each geographic region is displayed in a color corresponding to the peak pressure estimated arrival time associated with that region; and
causing, in response to a user input on the computing device that selects a particular geographic region of the plurality of geographic regions, the user computing device to display the particular geographic region in association with a graph that indicates the predicted pressure values for that particular geographic region over time, and that indicates when the predicted peak pest pressure for that particular geographic region is expected to occur.

9. The method of claim 8, further comprising causing the computing device to display a peak pressure estimated arrival time scale in association with the plurality of geographic regions.

10. The method of claim 8, wherein the graph includes a movable slider.

11. The method of claim 10, further comprising causing the computing device to dynamically display degree day information based on a position of the moveable slider.

12. The method of claim 8, further comprising causing the computing device to display predicted pest pressure levels for sub-regions of the particular geographic region.

13. The method of claim 8, further comprising causing the computing device to display, for at least one additional geographic region, an indication of how long it has been since a past peak pest pressure occurred.

14. The method of claim 8, further comprising, in response to a user selection, causing the computing device to display growing degree days intervals for a pest associated with the particular geographic region.

15. A computer-readable storage medium having computer-executable instructions embodied thereon, wherein when executed by a pest pressure prediction computing device including at least one processor in communication with a memory, the computer-readable instructions cause the pest pressure prediction computing device to:
receive historical pest pressure data for a geographic location, the historical pest pressure data including current and past pest pressure data for the geographic location;
receive weather data for the geographic location, the weather data including current and historical weather conditions for the geographic location;
apply a machine learning algorithm to the historical pest pressure data and the weather data to generate predicted future pest pressure data for the geographic location;
determine, from the predicted future pest pressure data, for each of a plurality of geographic regions within the geographic location, associated predicted pest pressure values, an associated predicted peak pest pressure, and an associated peak pressure estimated arrival time;
cause a computing device to display the plurality of geographic regions, wherein each geographic region is displayed in a color corresponding to the peak pressure estimated arrival time associated with that region; and
cause, in response to a user input on the computing device that selects a particular geographic region of the plurality of geographic regions, the user computing device to display the particular geographic region in association with a graph that indicates the predicted pressure values for that particular geographic region over time, and that indicates when the predicted peak pest pressure for that particular geographic region is expected to occur.

16. The computer-readable storage medium of claim 15, wherein the instructions further cause the pest pressure prediction computing device to cause the computing device to display a peak pressure estimated arrival time scale in association with the plurality of geographic regions.

17. The computer-readable storage medium of claim 15, wherein the graph includes a movable slider.

18. The computer-readable storage medium of claim 17, wherein the instructions further cause the pest pressure prediction computing device to cause the computing device to dynamically display degree day information based on a position of the moveable slider.

19. The computer-readable storage medium of claim 15, wherein the instructions further cause the pest pressure prediction computing device to cause the computing device to display predicted pest pressure levels for sub-regions of the particular geographic region.

20. The computer-readable storage medium of claim 15, wherein the instructions further cause the pest pressure prediction computing device to cause the computing device to display, for at least one additional geographic region, an indication of how long it has been since a past peak pest pressure occurred.
